(19) United States
(12) Patent Application Publication
(10) Pub. No.: US 2003/0053625 A1
(43) Pub. Date: Mar. 20, 2003

(54) Self-synchronizing, stream-oriented data encryption technique

(75) Inventors: Theodore Bially, Sudbury, MA (US); Harry B. Lee, Bellevue, WA (US)

Correspondence Address: WEINGARTEN, SCHURGIN, GAGNEBIN & LEBOVICI LLP, TEN POST OFFICE SQUARE, BOSTON, MA, 02109, US

(73) Assignee: THE TITAN CORPORATION

(21) Appl. No.: 10/230,652

(22) Filed: Aug. 29, 2002

Related U.S. Application Data
(60) Provisional application No. 60/318,448, filed on Sep. 10, 2001.

(51) Int. Cl. H04L 9/00

(52) U.S. Cl. 380/42; 380/278

(57) ABSTRACT

In an encryption system, a serial data stream is demultiplexed into a plurality N of encryptor input data streams to form a sequence of encryptor input data slices applied to an encryptor having a cascade of stages. Each stage includes a mapping function and a delay function, the mapping function performing a stage-specific direct mapping of data slice values to corresponding generally different data slice values, and the delay function applying stage-specific and generally different delays to individual symbols of data slices. Encrypted data slices generated by the last stage of the encryptor are transmitted through a transmission channel and received at a decryptor having a cascade of stages. Each decryptor stage includes an equalizing delay function and an inverse mapping function to generate output data slices from input data slices. Each output data slice of the last decryptor stage comprises respective values at a given time of a set of N decryptor output data streams, which are multiplexed together to recover the serial data stream.

### CROSS REFERENCE TO RELATED APPLICATIONS

This application claims priority under 35 U.S.C. §119(e) of U.S. Provisional Patent Application No. 60/318,448 filed Sept. 10, 2001, the disclosure of which is hereby incorporated by reference.

### STATEMENT REGARDING FEDERALLY SPONSORED RESEARCH OR DEVELOPMENT

Not Applicable

### BACKGROUND OF THE INVENTION

A wide range of data encryption algorithms, or ciphers, have been developed for storing information in a secure manner, and for securely transmitting information in digital data communication systems. Many algorithms provide good performance in the sense that it is extremely difficult or impracticably time consuming for an adversary to extract the protected data from the encrypted signal. Despite the proliferation of digital encryption schemes, none appear to have been reported in the pertinent literature that exhibit certain significant properties of an encryption technique described herein, and virtually all require considerably more computation for encryption and decryption and/or to generate key streams.

Encryption and decryption techniques utilize an algorithm referred to as an “encryption algorithm” to transform information of interest into an altered form suitable for secure storage or transmission. The objective of the encryption operation is to render the information unintelligible to an unauthorized user (or interloper). By utilizing a related algorithm referred to as the “decryption algorithm”, an authorized user can transform the altered information back to the original format.

Modern encryption/decryption algorithms generally utilize digital processing techniques. The information of interest typically is presented to the encryption algorithm in a digital format, and consists of a binary sequence generally called “cleartext”. The encryption algorithm typically is realized by means of a digital device referred to as an “encryption module” or “encryptor”. The encryption module transforms the cleartext into one or more related digital sequences known as “ciphertext”, which constitutes the desired storage or communications format. The ciphertext can be provided as input to the decryption algorithm, which transforms the ciphertext back to the original cleartext. The decryption algorithm typically is realized by means of a digital device referred to as a “decryption module”, or “decryptor”.

Modern encryptors and decryptors are keyed devices, in which proper operation is enabled by a vector of bits designated as the “session key”, or by a very long pseudo-random sequence of bits designated as a “key stream”, which is typically generated using a session key as the starting point. The purpose of the session key and/or key stream is to enable transformation of cleartext into ciphertext in such a manner that an interloper, with complete knowledge of the encryptor and decryptor, cannot reconstruct the cleartext from the ciphertext without the key used to encrypt the ciphertext. Typically, the session key and/or key stream is a sequence of random-appearing bits.

Modern data encryption algorithms fall into two general classes: symmetric and non-symmetric. The characteristics of these classes, and some representative algorithms from each, are briefly described below.

Symmetric algorithms generally use the same key for both encryption and decryption, and they employ essentially identical processing mechanisms for both tasks. Examples of symmetric algorithms include stream ciphers based on the logical “exclusive-OR” (XOR) function, and the block-oriented Data Encryption Standard (DES) in which the input data is segmented into fixed-length blocks, and encryption/decryption is applied on a block-by-block basis. Neither approach is self-synchronizing; both require that the decryption processor be correctly time-aligned with the encryption processor. Following are brief descriptions of both approaches.

Stream ciphers based on the XOR function utilize long pseudo-random key streams to encrypt cleartext and to decrypt ciphertext. The encryption algorithm creates the ciphertext by performing bit-by-bit exclusive OR-ing of the cleartext with the key stream. For a well-selected key stream, the resulting ciphertext bears no discernable relationship to the cleartext. The corresponding decryption algorithm consists simply of exclusive OR-ing the ciphertext by exactly the same key stream. This approach requires (1) that the encryptor and decryptor have access to the same key stream, and (2) that the decryptor key stream be time-aligned (synchronized) with that of the ciphertext.

Key stream generation generally starts with a code word, or session key, from which a unique key stream can be produced using an algorithm that may involve long shift register sequences, numerical manipulations and non-linear processing techniques. In real-time communications applications, the key stream generation algorithm must run in both the encryptor and decryptor at a rate commensurate with that of the transmitted data stream. For wideband systems, this often dictates the use of special high speed hardware and parallel implementations, resulting in products having large form factors and relatively high power consumption. The application of the key stream to the data (i.e., the actual encryption or decryption) is a simple one-bit exclusive-OR operation, but the cost and complexity of the encryption hardware is dominated by the high speed key stream generation process. In addition, the need for temporal alignment necessitates the insertion of unencrypted synchronization codes into the ciphertext stream to allow the decryptor to properly time-align its internally generated key stream. These timing signals represent potential weaknesses insofar as they can be detected by an informed interloper. Additional cost and complexity is needed in order to suppress this vulnerability.

The Data Encryption Standard (DES) encryption/decryption algorithm was developed by IBM in the 1970s in response to a solicitation by the National Bureau of Standards. For the last 20 years, DES and variants thereof have been the dominant encryption algorithms for commercial applications, banking and government.

The input to a DES encryptor is a cleartext message formatted as a binary sequence. The cleartext is transformed into ciphertext by first segmenting the cleartext into 64-bit blocks, and then performing block-by-block encryption. Each 64-bit block of cleartext is transformed into a 64-bit block of cipher text by means of a sequence of 16 successive transformations, known as Feistel rounds. A single 8-byte key with 56 user selectable bits determines the details of the transformation performed in each round. Each round performs three types of operations: exclusive-OR (XOR) of input data bits (or intermediate data bits) with key bits, substitution, and permutation. The details differ from round to round, and have been carefully orchestrated to minimize attackable weaknesses. The complexity of DES derives from so-called “S boxes”, which are table lookup operations that realize the substitutions.

DES decryption is the inverse of encryption. Specifically, 16 inverse rounds of XOR, substitution and permutation are performed in reverse order relative to the encryption rounds.

DES is a block-oriented algorithm. The decryption algorithm is successful only if each 64-bit block that it operates upon is an actual 64-bit block that has been created by the encryption algorithm. Specifically, in communications applications, some mechanism is required for correctly synchronizing the (block) decryption operation with the 64-bit block boundaries. Thus DES is not a self-synchronizing encryption/decryption algorithm except if used in a highly inefficient and computationally-intensive mode, e.g., by effecting full 64-bit DES encryption separately on each bit of cleartext and the most recent 63 bits of ciphertext.

In contrast to symmetric algorithms, non-symmetric algorithms use different (but intimately related) numerical keys for the receiver and transmitter. The most popular class of non-symmetric encryption algorithm is the “public key” system, in which a receiver-specific “public” encryption key is provided to anybody who wishes to send an encrypted message to that receiver. Once a message is encrypted with a receiver's public key it can be decrypted using a “private” key which is known only to the receiver. Accordingly, only the intended receiver is able to decipher a message that has been encrypted using its freely-distributed public key, regardless of where the message may have originated. Variations of this approach have been developed for authentication purposes and digital signature validation in addition to message encryption.

Public key encryption algorithms are computationally intensive and inherently block-oriented. The public key encryption mechanism is considerably more complex than exclusive OR-ing the data. Data streams are first segmented into contiguous blocks, typically containing upwards of 64 or 128 bits each. Individual blocks are then subjected to a sequence of mathematical manipulations that include raising large, hundred-plus digit integers to high numerical powers and expressing the results modulo certain prime numbers or products of certain prime numbers. These operations involve multiplication and division of extremely large integers, which must be performed without quantization or truncation in order to preserve the ability to decrypt without error.

Additionally, the block orientation of non-symmetric algorithms carries with it an inherent need for synchronization (e.g. to identify block boundaries). Accordingly, non-symmetric algorithms are generally better suited to packet communication environments than to streaming data applications. Also, because of the compute-intensive nature of the processing, non-symmetric algorithms are impractical for direct application in high data rate systems. A common application is as a means of securely communicating symmetric keys between receivers and transmitters in the start-up phase of a symmetrically encrypted data transaction.

It would be desirable to devise an encryption algorithm that overcomes the principal limitations of both families of existing encryption algorithms, both symmetric and non-symmetric. In particular, it would be desirable to devise an encryption algorithm that does not require generating a key stream from a symmetric key, nor require any timing synchronization. Additionally, an algorithm having minimal computational complexity would be capable of being operated at high data rates using relatively simple and inexpensive hardware, enabling a broader base of potential data communications applications.

### BRIEF SUMMARY OF THE INVENTION

In accordance with the present invention, an encryption technique exhibiting the above desirable attributes is disclosed.

In the disclosed technique, a serial data stream to be securely transmitted is first demultiplexed into a plurality N of encryptor input data streams. The set of N respective values of the encryptor input data streams at any given time are referred to as an “encryptor input data slice”.

The encryptor input data slices are applied to an encryptor having a cascade of stages, wherein each stage includes a mapping function and a delay function to generate stage output data slices from stage input data slices. In each stage, the mapping function performs a stage-specific direct mapping of data slice values to corresponding generally different data slice values, and the delay function applies stage-specific and generally different delays to individual symbols of data slices. The encrypted data slices generated by the last stage of the encryptor are transmitted through a transmission channel.

The encrypted data slices received from the transmission channel are applied to a decryptor having a cascade of stages, wherein each stage includes an equalizing delay function and an inverse mapping function to generate output data slices from the mapped data slices. Each output data slice of the last decryptor stage comprises respective values at a given time of a set of N decryptor output data streams. The decryptor output data streams are multiplexed together to recover the serial data stream.

The encryptor and decryptor require no synchronization to block boundaries or other timing references other than those provided implicitly by standard serial transmission protocols, and therefore operate in a simple stream-oriented fashion. Further, the mapping functions are preferably straightforward N:N mappings that can be easily implemented in table lookups, avoiding the need for expensive arithmetic logic. The overall encryption system provides very robust data security in an efficient and relatively uncomplicated manner as compared to prior encryption systems.

Delay values and mapping tables in the encryptor and decryptor are derived from a numerical session key, using an agreed-upon computational procedure which is commonly available at all user sites. A significant difference between this approach and prior stream cipher methods is that the session key is used to derive processing parameters (tables and delays) of the encryptor and decryptor in advance of the actual data transmission, instead of being used to generate a key stream at real-time rates. An exemplary algorithm for generating parameters from a session key is disclosed that exhibits desired randomness while being straightforward to implement and computationally efficient.

A programmable microprocessor or equivalent computing device may be used for interface and message exchange with a key management and distribution system such as the Public Key Infrastructure (PKI), and for deriving encryptor and decryptor mapping tables and delay parameters from the actual session key. After the processing parameters for a specific session have been applied to the encryptor and decryptor, they may be held constant for the entire duration of the ensuing stream data transmission.

Other aspects, features, and advantages of the present invention will be apparent from the detailed description that follows.

### BRIEF DESCRIPTION OF THE SEVERAL VIEWS OF THE DRAWING

The invention will be more fully understood by reference to the following Detailed Description of the Invention in conjunction with the Drawing, of which:

FIG. 1 is a block diagram illustrating an encryption/decryption technique in accordance with the present invention, including the distribution of a key by a key distribution system and the providing of encryption/decryption parameters based on the key;

FIG. 2 is a block diagram illustrating the general architecture of the encryption/decryption technique of FIG. 1;

FIG. 3 is a block diagram depicting the multi-stage nature of the encryptor of FIG. 2;

FIG. 4 is a block diagram of a single stage element of the encryptor of FIG. 3;

FIG. 5 is a block diagram depicting the multi-stage nature of the decryptor of FIG. 2;

FIG. 6 is a block diagram depicting the inverse relationship between the encryptor single stage element of FIG. 4 and a corresponding decryptor single stage element in the decryptor of FIG. 5;

FIG. 7 is a block diagram depicting an alternative, equally general, encryptor and decryptor configuration;

FIG. 8 is a block diagram depicting intra-stage data-dependent configuration in the general encryption/decryption technique of FIG. 1;

FIGS. 9 and 10 are block diagrams of more generalized versions of the encryptor and decryptor respectively of FIGS. 3 and 5;

FIG. 11 is a block diagram illustrating the application of a random bit stream to the cleartext in conjunction with the general encryption/decryption technique of FIG. 1; and

FIG. 12 is a block diagram illustrating an alternative manner of applying a random bit stream to the cleartext in conjunction with the general encryption/decryption technique of FIG. 1.

### DETAILED DESCRIPTION OF THE INVENTION

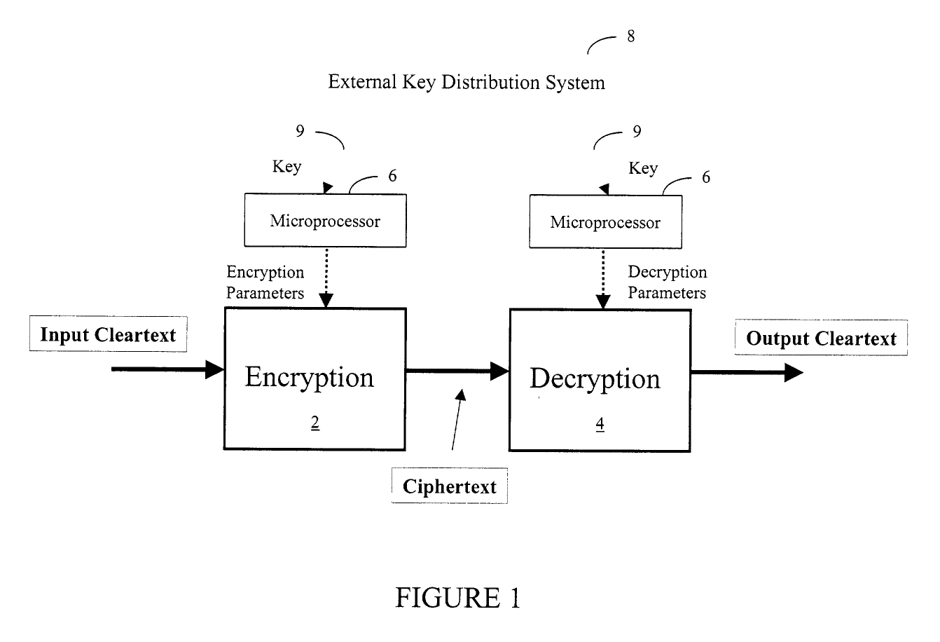

FIG. 1 shows a system in which input cleartext is provided to an encryption block 2 to generate ciphertext, which is transmitted to a decryption block 4 for decryption so as to generate output cleartext that is the same as the input cleartext. Microprocessors 6 or equivalent computing elements associated with the encryption and decryption blocks 2, 4 respectively each receive the session key from a key distribution system 8 via a secure key distribution mechanism (e.g., “public key infrastructure” (PKI)). The key distribution system 8 may be entirely separate from the encryption/decryption system, relying on separate channels 9 for distributing the key, or may be more tightly integrated with the encryption/decryption system. For example, part or all of the key distribution system 8 may be co-located with the encryption block 2, with the key being provided to the decryption block 4 via the same signal path on which the ciphertext is carried.

The microprocessors 6 generate appropriate encryptor and decryptor parameter sets based on the received key using the identical parameter generation algorithm or “key schedule.” Alternatively, the actual encryptor and decryptor parameters may be generated remotely and communicated securely to the encryption block 2 and decryption block 6 in lieu of an explicit key. In either case, the parameters include tables and sets of delay values used in the encryption and decryption processes, as described further below.

A simple key generation method that is well suited to this application, is to pick a random number of as many bits as are desired in the key and use it as the seed for a pseudo-random number generator in the microprocessors 6 at all user sites. The encryption and decryption parameters (i.e., table entries and delay values) are calculated from the stream of numbers generated by the pseudo-random generator. In addition to having identical pseudo-random generators, all sites must also use a common algorithm (key schedule) for producing the encryption and decryption parameters from the stream of numbers from the pseudo-random generator. Thus, any user who seeds his pseudo-random generator with the correct seed (i.e., with the correct key), will obtain a correct set of encryption/decryption parameters. An example key schedule is described below. The approach includes a novel and computationally efficient technique for generating pseudo-random number sequences based on arbitrarily long user-defined keys, using a plurality of very simple but shorter length numerical sequence generators.

The above-described parameter generation method has the virtue of decoupling the key length, which can be arbitrary, from the actual configuration parameters that define the encryption block 2 or decryption block 4. Note that in this approach a key length of B bits selects among only 2^{B} different encryption/decryption configurations. This is generally a small subset of all possible configurations.

After the parameter sets have been transferred to the encryption block 2 and decryption block 4, stream data transmissions proceed via the encryption block 2 and decryption block 4 only, with no further activity required of the microprocessor 6 until such time as a new key may be desired. Depending on the application, it may be advantageous to retain the same key for the entire duration of a stream transaction (e.g., a full-length movie) or to change it at more frequent intervals.

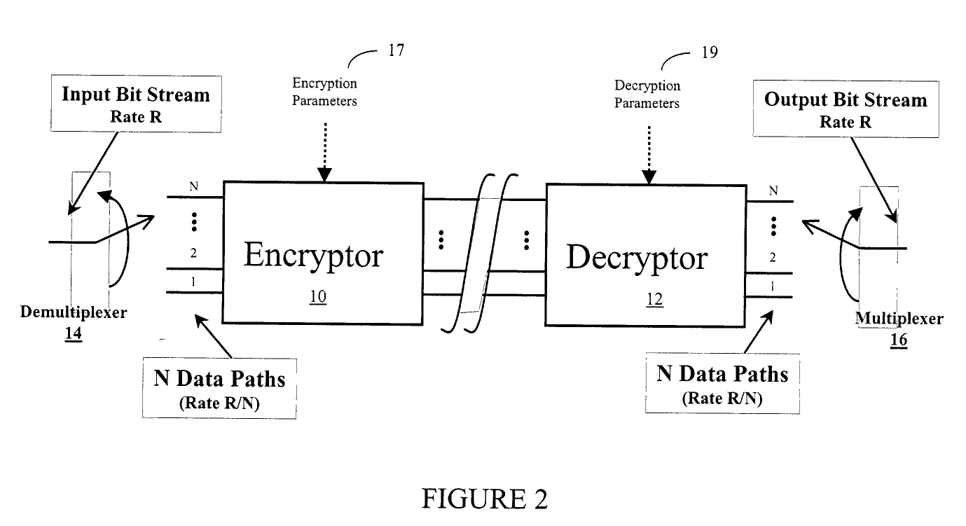

Referring to FIG. 2, the input cleartext stream data is presented to an encryptor 10 on N parallel paths which are clocked synchronously. The output of a decryptor 12 likewise appears in data slice form, on N parallel paths. Encryptor outputs and decryptor inputs (ciphertext) are also N-bit data slices. Path identities are preserved in the encryption/decryption process, that is, data provided as an input to the encryptor 10 on input path ‘n’ appears as an output of the decryptor 12 on output path ‘n’. The data may generally employ any type of data symbol format. For ease of description, it is assumed herein that the data employs binary symbols (1's and 0's).

Although other configurations are possible, it is assumed that the data to be encrypted originates as a single clocked stream of binary data. The first step in the processing is therefore to distribute, or demultiplex, the input stream of rate R bits per second into N separate streams, each of rate R/N bits per second. Input demultiplexing is performed by demultiplexer 14 in FIG. 2. At each sample instant, a set of N input bits are presented to the encryptor 10; this set of bits is designated herein as a data “slice”. Both encryption and decryption are performed on a slice-by-slice basis. A final step after decryption is to recombine the cleartext slices into a single stream at rate R that duplicates the original input. This function is performed by an output multiplexer 16.

Reconstruction of the input serial data stream at the decryptor 12 requires only that, upon receipt of each new output data slice, the output multiplexer 16 sequence through the N decryptor outputs in the same order as that used by the input demultiplexer 14 in composing input data slices. This condition is easily satisfied at a hardware level and requires no external timing or control.

The system as shown in FIG. 2 accepts a single input data stream, and after encryption and subsequent decryption, it delivers that same stream without synchronization or timing control other than knowledge of the system clock rate. In order to thwart reverse-engineering by an interloper, the encryption and decryption algorithms are enabled by session-specific parameter sets as indicated at 17, 19 in FIG. 2, and discussed above with reference to FIG. 1.

FIG. 2 additionally shows that the outputs of the encryptor 10 also exist on N parallel data paths, and that the same N parallel data paths are applied as input to the decryptor. Further, as described in more detail below, encrypted data on any of the N output paths of the encryptor 10 is influenced by all of the input data, i.e., by data from all N input paths. The N encryptor outputs may be sent to the decryptor 12 over a parallel set of N ordered channels (e.g., wires, wavelengths, etc.), or they may be multiplexed into a single stream for transmission and demultiplexed back into N streams at the input to the decryptor. Such multiplexing/demultiplexing must preserve the identities of the encryptor outputs, so that they are correctly applied to their corresponding decryptor inputs at the receiving end of the link. For example, the identity can be preserved by transmitting the output stream of N-bit slices over a common channel using any of several standard serial transmission protocols such as Ethernet or SONET, that preserve the byte, word and symbol-level integrity of the data.

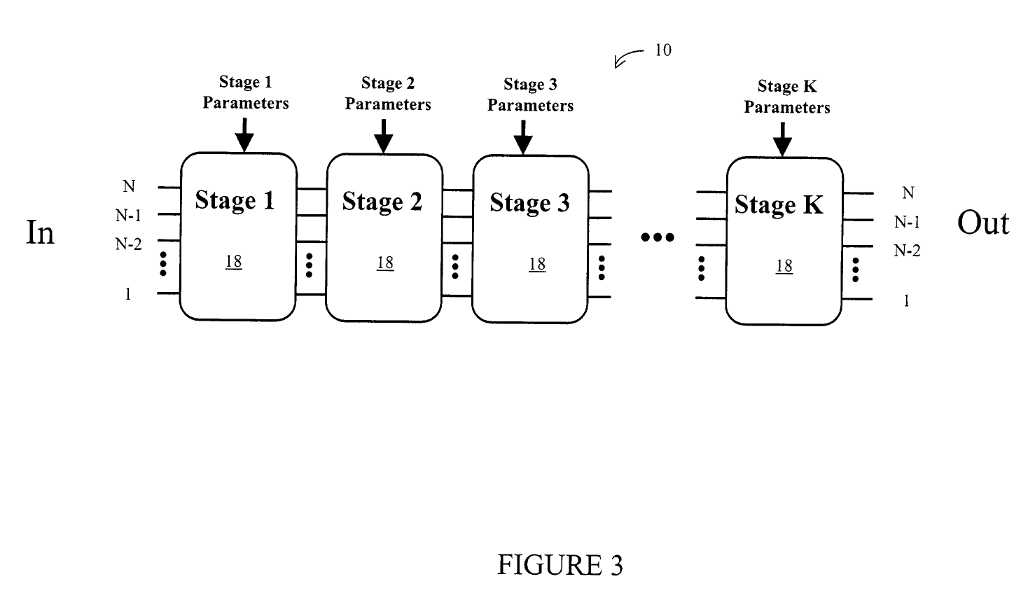

Turning now to FIG. 3, the encryptor 10 is shown as consisting of a concatenated sequence of similar stages 18. Each stage 18 has N input paths and the same number of output paths, and the outputs of one stage 18 connect directly to the inputs of the next stage 18. FIG. 3 shows a K-stage encryptor 10 with N parallel data paths, wherein N and K are fixed integer parameters of the design. In a preferred hardware implementation, this is a synchronously clocked system in which the data slices that are input to individual stages are transformed to output data slices of those same stages, simultaneously in all stages. Accordingly, in this “pipeline” architecture, an input to Stage 1 begins to affect the output of Stage K K clock cycles later.

Different choices of N and K produce different variants of the generic architecture. Values of N in the range from 3 to 8 can provide effective elementary encryption. Larger values of N are possible and work well, although their use will generally increase the complexity of the hardware and could result in slower operation in the absence of compensating mechanisms. The number of stages, K, can be as few as 3 or 4, but is preferably larger, because the number of session-specific encryption and decryption parameters (and therefore the degree of protection) is greater with more stages. Speed of operation is generally not affected by increasing the number of stages, because of the pipeline nature of the cascade architecture. The choice of K is generally dictated by predominantly hardware considerations.

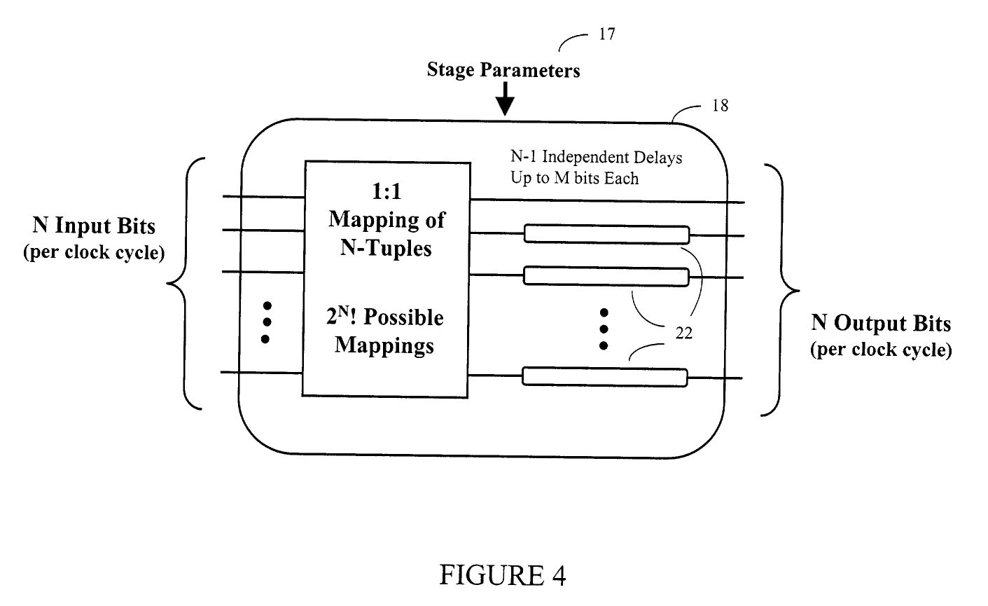

FIG. 4 shows the internal structure of a generic stage 18 of the baseline encryptor 10. The N data bits (or data slice) that appear at the input to the stage 18 at each clock cycle are treated as an address, or pointer, into a lookup table 20 that performs a permution operation. Generally, the table 20 has 2^{N} entries, which are themselves N-bit quantities (slices), with the constraint that every unique N-bit combination appears once and only once as a table entry. The table 20 therefore defines a one-to-one mapping of slices, or N-tuples. There are 2^{N}! different possible tables or mappings, corresponding to the number of unique ways 2^{N} items may be shuffled. Every stage 18 in the encryptor 10 generally uses a different mapping. Mappings may be selected at random or pseudo-randomly in accordance with a key schedule, using indepented choices for the different stages. However, some mappings are less useful than others, e.g., the identity mapping which is equivalent to no mapping at all. The following table shows a representive mapping for the case N=3. This is one of 40,320 (2³!)different possibilities.

| IN | OUT |
|---|---|
| 000 | 010 |
| 001 | 111 |
| 010 | 101 |
| 011 | 001 |
| 100 | 000 |
| 101 | 110 |
| 110 | 100 |
| 111 | 011 |

Also shown in FIG. 4 is that within each stage 18, individual bits table output N-tuple are applied to clocked delay elements 22, which may be for example adjustable length one-bit shift registers. These delays are separate from, and additive to, any implicit stage-to-stage pipeline delays. The stage 18 receives a parameter set 24, which is derived from the overall key. The parameter set 24 for each stage 18 of the cascade specifies both the delay values and the mapping to be used in that stage. Table values and delay parameters are preferably stored locally in the encryptor and decryptor hardware, e.g. in random access memories.

It is desirable that at least one of the delay elements 22 in each stage have the value zero (i.e., no delay), while the remaining N−1 may be selected at random. Assuming the maximum allowable value of delay in any one stage is M clock intervals and that at least one of the delay values is non-zero, the number of different possible delay configurations for a stage is:

$${\sum }_{n = 1}^{N - 1} \frac{( N ! )}{n ! ( N - n ) !} {M}^{N - n} = {\sum }_{n = 1}^{N - 1} ( \begin{matrix}N \\ n\end{matrix} ) {M}^{N - n}$$

Multiplying the number of possible mappings by the number of delay configurations yields the number of different possible stages. Combining this with number of possible mappings gives

$${2}^{N} ! {\sum }_{n = 1}^{N - 1} ( \begin{matrix}N \\ n\end{matrix} ) {M}^{N - n}$$

as the number of possible single stage configurations. Finally, raising this quantity to the K^{th} power gives the number of different possibilities for a system of K stages. A K-stage encryptor therefore has

$${[ {2}^{N} ! {\sum }_{n = 1}^{N - 1} ( \begin{matrix}N \\ n\end{matrix} ) {M}^{N - n} ]}^{K}$$

different possible configurations. For example, the comparatively simple case N=3, K=8 and M=16 provides approximately 1.37×10⁶⁰ different configurations.

The set of encryptor configurations enumerated above includes certain redundancies. In other words it can be shown that for any selected configuration of delays and mappings, a number of other configurations always produce exactly the same results. If it is desired, one way to reduce the number of redundant configurations is to impose certain constraints on the delays used in any stage:

1. Allow no two of the N delay values in any one stage to be equal.

2. Permit each set of N specific delay values to appear in only one of the allowable configurations. This can be accomplished, e.g., by always arranging the delays in monotonically increasing or decreasing order on the N paths.

Under these constraints the number of distinct delay configurations per stage is reduced to

$$\frac{M !}{( N - 1 ) ! ( M - N + 1 ) !} = ( \begin{matrix}M \\ N - 1\end{matrix} )$$

and, consequently, the number of allowable system configurations for a K-stage encryptor becomes

$${( {2}^{N} ! ( \begin{matrix}M \\ N - 1\end{matrix} ) )}^{K} .$$

For the above example of N=3, K=8 and M=16, this equates to approximately 3.0×10⁵³ different configurations compared to 1.37×10⁶⁰ for the unconstrained case. The formulas represent upper bounds on the number of functionally distinct encryptor configurations.

With respect to the constraint that at least one of the delay elements in each stage be zero, it can be shown that if this were not the case, a multiplicity of delay configurations could produce the same output function, albeit with different overall delay (or latency). The zero delay restriction assures that each allowed set of delay values produces a different encryption function.

It is also advantageous to assure that at least one delay element in each stage, with the possible exception of the last, be non-zero. This avoids degenerate cases that cause two mappings to merge into one equivalent mapping, thereby reducing the effective number of stages in the cascade. It may sometimes be desirable to set all the delays in the last stage of the encryptor equal to zero.

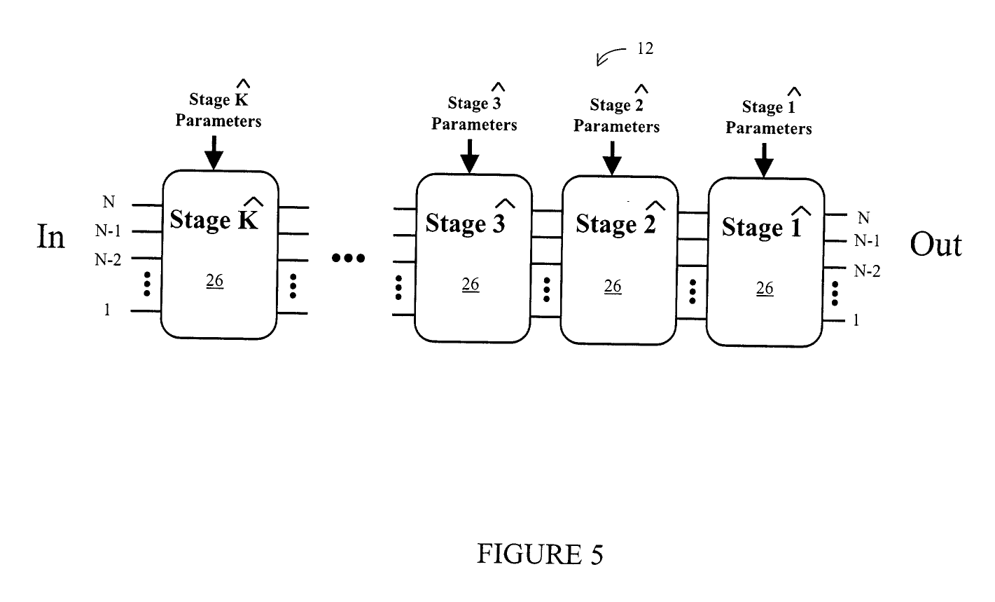

With reference to FIG. 5, the architecture of the decryptor 12 is generically the same as that of the encryptor 10 (FIG. 3), with the following attributes:

b 1. Each stage 26 is the inverse of a corresponding stage 18 in the encryptor 10. Inverse stages are indicated with circumflex marks (ˆ ).

2. The inverse stages 26 are concatenated in reverse order relative to the those of the encryptor 10.

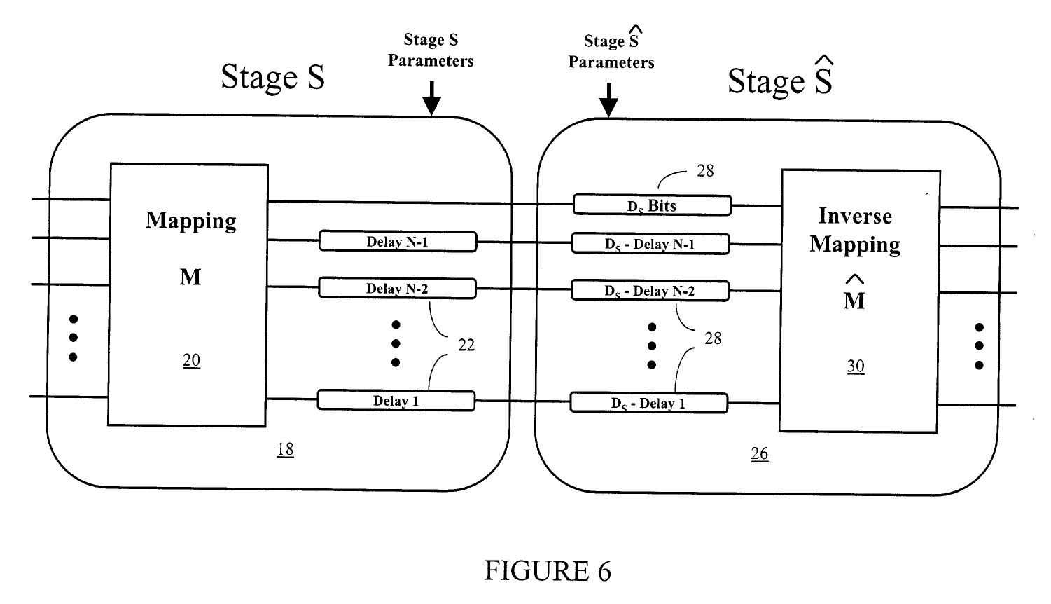

FIG. 6 shows an example encryptor stage 18 and its inverse decryptor stage 26. Mapping and delay parameters of the decryptor stage 26 can be derived in a one-to-one way from those used in the corresponding encryption stage. To facilitate discussion, the outputs of the encryptor stage 18 are shown connected directly to the corresponding inputs of the inverse stage 26. Note that in the inverse stage 26, the delay elements 28 appear before the inverse mapping operation 30, whereas the delay elements 22 in the encryptor stage 18 appear after the mapping 20. The mapping 30 used in the inverse stage 26 is the inverse of the mapping 20 used in the encryptor stage 18.

Delay values for the inverse stage 26 are chosen such that the total delay from the output of the encryptor mapping 20 to the input of the inverse mapping 30 is identical (equalized) in each of the N paths. The delay elements 28 of the inverse stage 26 are selected to satisfy this relationship. The quantity Ds shown in the specification of the delays 28 in the inverse stage 26 is equal to (or greater than) the value of the longest of the delay elements 22 in the corresponding encryption stage 18.

An inverse mapping 30 can be derived from the forward mapping 20 simply by interchanging the input and output columns in the mapping table. For example, the mapping of the above table is reproduced below along with its inverse. The rows of the inverse table have been rearranged to appear in ascending numerical order of the input N-tuples.

| | |
|---|---|
| Forward | Inverse |

| IN | OUT | IN | OUT |
|---|---|---|---|
| 000 | 010 | 000 | 100 |
| 001 | 111 | 001 | 011 |
| 010 | 101 | 010 | 000 |
| 011 | 001 | 011 | 111 |
| 100 | 000 | 100 | 110 |
| 101 | 110 | 101 | 010 |
| 110 | 100 | 110 | 101 |
| 111 | 011 | 111 | 001 |

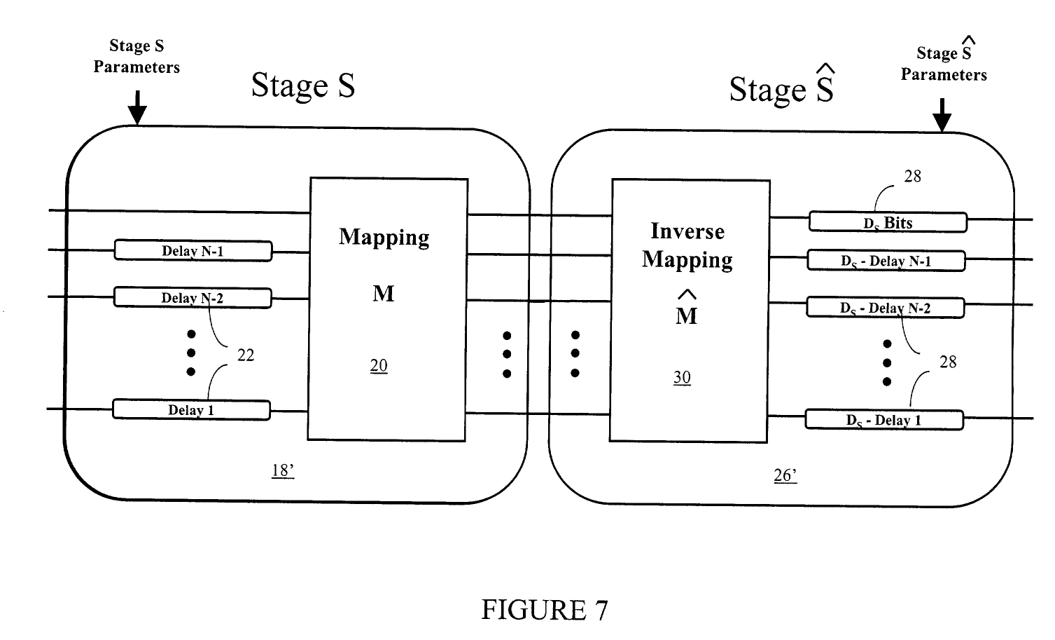

As described above, individual stages 18 of the encryptor 10 consist of a mapping function 20 followed by delay operators 22, and decryptor stages 26 contain delay operators 28 followed by an inverse mapping function 30. This is an arbitrary distinction, since it would be equally valid for an encryption stage 18 to contain the delay elements 22 first and the mapping 20 second, in which case the inverse mapping 30 would be first in the corresponding decryption stage 26, followed by the delays 28. Such a configuration is shown in FIG. 7. Results derived for the comfiguration of FIG. 6 are equally applicable to that of FIG. 7, and vice-versa. Accordingly, and without loss of generality, we limit the discussion to the system configuration shown in FIG. 4 and 6.

The above-described system represents a baseline form of the disclosed encryption/decryption approach. This algorithm exhibits the following properties:

1. The encrypted data on each output path of the encryptor 10 is a function of the input data on all input paths. The exact relationship depends on the specific choices of mappings and delays, of which there are manifold.

2. In the absence of transmission errors, the output of the decryptor 12 is an exact replica of the encryptor input with the exception of a fixed time delay. The amount of time delay (latency) is a function of the delay elements 22, 28 in the individual stages.

3. The encryptor 10 and the decryptor 12 are each shift-invariant. That is to say, for either device, a delayed replica of its input produces a commensurately delayed replica of its output.

4. The encryptor 10 and decryptor 12 are finite memory systems. This means that at a given instant of time, the output of either device is a function only of its internal parameters (mappings, delays) and of the data applied to its input in the most recent DT clock cycles. DT is computed by finding the longest delay in each decryptor stage and summing these over all decryptor stages.

Properties 3 and 4 above result in a self-synchronizing capability, in which input data can be applied to the decryptor without knowledge of a starting point or block boundary. Correctly decrypted output appears after a delay of DT cycles.

While the shift-invariant and finite memory aspects of the baseline algorithm are highly advantageous for decryption, these same properties introduce a certain vulnerability into the encryption process. Specifically, the same input data sequence applied to the encryptor 10 at one or more later times generates identical segments of encrypted output. This happens when the repeated sequence is substantially longer than DT bits.

There are two modifications to the baseline algorithm that 1) introduce time variability into the mappings, thereby making it considerably more difficult to infer the mapping parameters through observation of the encrypted data stream, while also significantly increasing the number of possible encryptor configurations, and 2) eliminate the above-described repeatability weakness. Depending on the application and on the required strength of the encryption, the baseline algorithm may be used as-is, or with either or both of the described modifications.

A characteristic of the baseline design is that all of the mapping functions are held fixed throughout the duration of a data transaction. Given a sufficiently long data stream and some knowledge of the input cleartext (e.g., a repeating sub sequence which is part of an embedded data protocol), it may be possible (but highly unlikely) for an adversary to reverse-engineer some or all of the encryptor parameters by analyzing the encryptor output.

It is possible to introduce time variability into the mappings and at the same time increase the number of possible encryptor configurations. These changes result in significant strengthening of the encryption. In general, a time varying encryptor requires a matched, time-varying decryptor and, therefore, one that is not self-synchronizing. However, a technique for providing time variability shown herein retains the self-synchronization property of the baseline encryption/decryption process. The general approach is to change the mapping functions with each cycle of the system clock. The actual data flowing through the encryptor and decryptor is used to generate a code for selecting the specific mappings to be used at any instant.

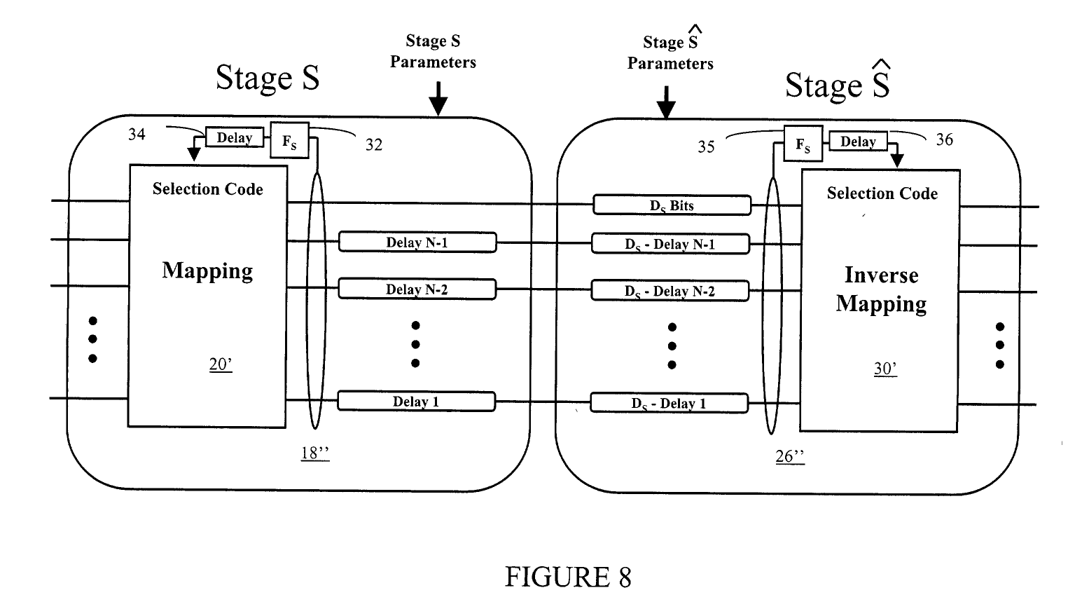

An exemplary intra-stage version of the idea is indicated in the left half of FIG. 8. A function F_{S} 32 is performed on an N-bit output slice of the encryptor mapping 20′ to produce an integer value which is used as a selection code, or index, to control the choice of mapping in the same stage on a subsequent clock cycle. In general, data slices from any downstream points in the encryption stage may be used in forming the intra-stage selection code. For example the stage output slice may be used in lieu of, or in conjunction with, the mapping output. However, the use of downstream outputs requires additional compensating delays in the decryption process whereas the use of the mapping outputs directly yields a somewhat less complex hardware design. Accordingly, and without loss of generality, we restrict the discussion of feedback encryption to architectures in which the encryption mappings are selected based on indices which are functions of the mapping outputs.

The time at which a given selection code is actually used depends on a delay element 34 forming part of the control path. The maximum number of distinct selection codes that can be achieved based on an N-bit data slice, is 2^{N}. Thus, as many as 2^{N} different mappings potentially can be associated with each stage, compared to a single mapping per stage in the baseline design. This results in a significantly expanded configuration space for the system since in this embodiment each stage switches among a multiplicity of mappings. Different, independently selected, mapping sets are used in the different stages, as determined from the key via the key schedule.

The introduction of dynamic, data dependent mapping selection requires that a multiplicity of mappings be defined and included in the parameter set for each stage of the encryptor. It additionally requires that the selector function F_{S} to be used within the stage for selecting among the available mappings, also be defined and included in the parameter set, along with an associated delay parameter.

As an example of how this selector function may be implemented, consider the case in which Q≦2^{N} different mappings are to be associated with a particular encryption stage, and that the choice of which mapping to use at a given instant is to be a function of a prior N-bit data slice of that stage's mapping output. A selector function of N bits can be expressed as a table of 2^{N} entries, in which each entry is an integer between 1 and Q. Table entries may be determined independently and pseudo-randomly in accordance with the key schedule, in a manner similar to that in which mapping tables and delay values are generated. Different tables, corresponding to different selector functions, may be used in each stage of the cascade, and the various stages may use different selection code delay values 34. This variability significantly enlarges the configuration space of the system.

It is also possible to form the selection function based on more than one prior data slice by using, e.g., P_{S} earlier data slice outputs of the stage mapping. This option requires additional memory in each stage to store the last P_{S} output slices and it employs a selection function of up to NP_{S} input bits.

Note that while the encryptor mapping is controlled in a feedback configuration, the decryptor stage 26″ operates in feed-forward mode. These circumstances enable each decryptor stage 26″ to determine the applicable inverse mapping to use at a subsequent instant, based on current and/or earlier data slices appearing at the input to its inverse mapping. Thus, each decryptor stage 26″ can apply the correct inverse mapping notwithstanding the time-variable nature of the mapping function. The decryptor uses the same selection control function 35 as that of the encryptor, and the same amount of selection code delay 36.

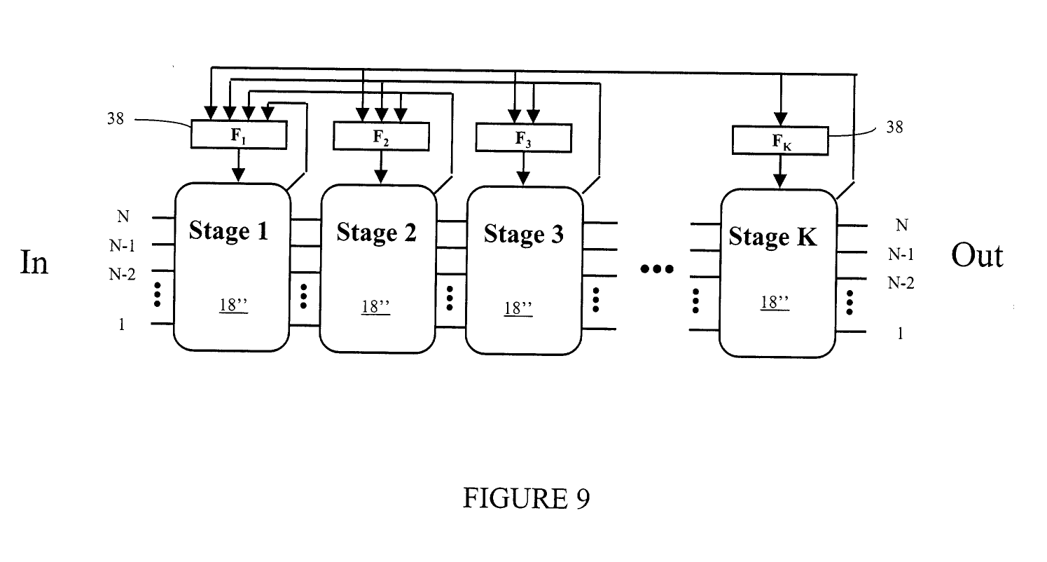

A more complex encryptor scheme, actually a generalization of the foregoing intra-stage design, is shown in the encryptor of FIG. 9. In this diagram, the control data for a given encryptor stage 18″ is taken to be a function of the mapping output data slices internal to that stage, plus selected mapping output data slices of generally all the downstream stages 18″ in the cascade. The blocks 38 labeled F₁, F₂, . . . , F_{K} contain the stage-specific selection logic functions and control path delay elements. The signal paths emanating from the upper right hand corner of the stages 18″ of FIG. 9 represent the symbols that appear at the outputs of the mappings which are internal to those stages, as shown for the example encryptor stage 18″ in FIG. 8. Note that the intra-stage architecture of FIG. 8 is a special case of the design depicted in FIG. 9 (i.e., where the function F_{X} for each stage of FIG. 8 depends only on the output of its own internal mapping and ignores the mapping outputs of downstream stages).

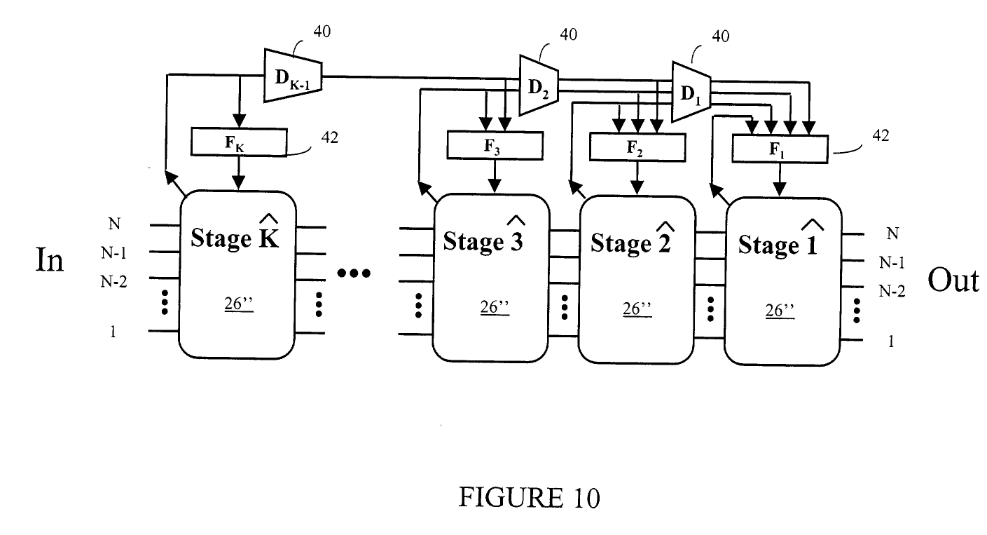

By analogy with the encryptor and decryptor pairs of FIGS. 3 and 5, the decryptor corresponding to the encryptor of FIG. 9 is a mirror image of that encryptor, with the mapping selection logic arranged in a feed-forward configuration. This decryptor architecture, which generalizes that of FIG. 5, is shown in FIG. 10. Analogously with FIG. 9, the arrows emanating from the upper left hand corner of the stages 26″ of FIG. 10 represent the symbols that appear at the inputs to the inverse mappings which are internal to those stages. Delay compensation 40 is inserted into the various selection control paths to properly time-align the inputs to selector function blocks 42. All control path segments that connect between two adjacent decryptor stages 26″ require the same amount of delay, equal to the longest of the N data path delays in the downstream (right-most) of the two stages. Again, the feed-forward architecture enables each stage to determine the applicable inverse mapping in advance of when that mapping must be applied to its input data slice.

As a practical matter, it is believed that a relatively simple intra-stage feedback approach of the type shown in FIG. 8, with the control function derived from a single output data slice, provides strong protection against reverse engineering of the key from observations of the encrypted output stream. It also provides an extremely large number of unique configurations using small values of N and relatively few stages. For example, an encryptor/decryptor system having a number of unique configurations in excess of 2⁴⁰⁰⁰ can be realized using the approach of FIG. 8, with parameters N=4, K=6, M=8 and 2^{N} (i.e., 16) mappings per stage. Further, it can be shown that the shift-invariant and self-synchronization properties of the baseline design are fully preserved in the above-described data-dependent, time-variable versions of the system.

A second modification of the baseline system is to introduce randomness into the encrypted output stream, so that the output of the encryptor 10 cannot be predicted based on the input data alone. This provides increased robustness against reverse engineering of the encryptor parameters by an adversary observing the encrypted data stream. A cost associated with this modification is that the bandwidth efficiency of the system is diminished somewhat, i.e., fewer message bits can be communicated over the channel per unit time than otherwise would be possible using the same encryption hardware as for the baseline algorithm. However, this loss of efficiency can be controlled by design, and the benefits may justify the cost in many applications.

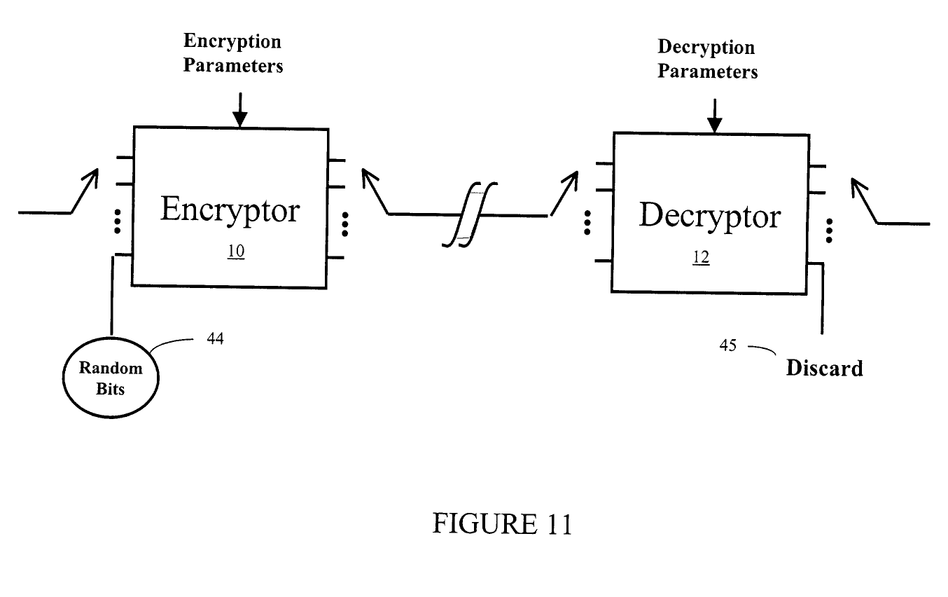

A randomization approach is illustrated in FIG. 11. It achieves the desired randomization while retaining the streaming and self-synchronization properties of the baseline system. Simply stated, a random bit stream 44 is applied to one of the input paths of the encryptor 10, while reserving the remaining paths for cleartext data. Since every input path affects every output path of the encryptor 10, the application of a random stream to even a single input serves to randomize all of the encryptor outputs. The receiver does not require a-priori knowledge of this bit stream in order to decrypt the cleartext. The random stream 44 may therefore be generated by arbitrary means, including analog methods.

As a consequence of introducing the random bit stream 44, the net data rate of the encrypted output is higher than that of the input user data by a factor of N/(N−1). This results from the fact that the random bit stream 44 occupies one of the encryptor's N input paths, leaving N−1 paths available for user data. For example, if N were 2, the encryptor output data rate would be twice that of the input stream. With N=6, the output rate is 20% higher than that of the input. Inclusion of the random bit stream 44 can be considered optional, depending on the application and on system-level design considerations. It is also possible to introduce random bits on more than one of the input paths. This may offer some advantage in special cases, although at the cost of further reduction in the bandwidth efficiency of the system.

When a random bit stream 44 is employed, the decryptor 12 functions exactly as it does for the baseline algorithm. Specifically, it decrypts the N binary sequences without knowledge of the random bit stream. Prior agreement between encryptor and decryptor as to which of the N data paths contains the random stream enables the decryptor 12 to simply discard the appropriate output sequence, as shown at 45.

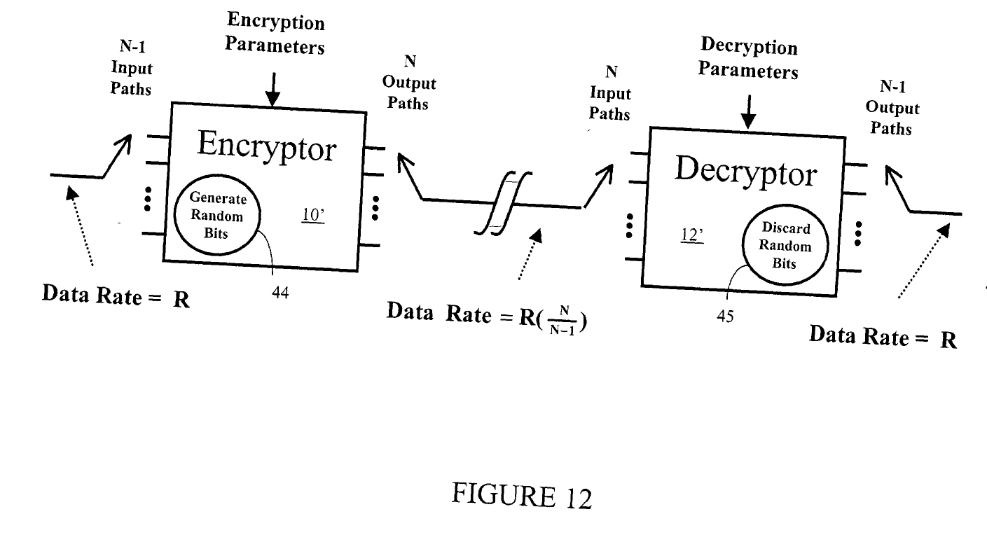

Since there is no need for either the sender or the receiver of the data to observe the inserted random stream 44, the stream itself may be generated internally in the encryptor hardware and discarded internally in the decryptor hardware. This architecture is indicated in FIG. 12. It shows the number of parallel input and output paths at the encryptor 10′ and decryptor 12′, plus serial data rates at key points in the system. Use of an inaccessible analog random bit generator (e.g., a noise diode) can assure that even the sender cannot control or predict the output of the encryptor 10′.

It will be observed that the encryptor input and decryptor output serial data streams each clock at a uniform rate of R bits per second, while the encrypted serial stream on the channel clocks at a uniform rate of R[N/(N−1)] bits per second. End users view the system as one that has N−1 encryptor input paths and N−1 decryptor output paths and for which the end-to-end behavior (e.g., with respect to streaming and self-synchronization properties) is identical to that of an N−1 path system without random bit insertion.

Thus far the disclosed technique has been described in the context of its application as a stream cipher. Here we extend the utility of the technique to block encryption.

Referring to the basic algorithm configuration (FIGS. 3-6), it is straightforward to show that if the input stream of data slices is periodic with period P, then the encrypted output stream of data slices is also periodic with period P. This observation leads to the following conceptual recipe for block encryption:

1. Start with a block of P data slices of plaintext. A data slice is an N-tuple of 1's and 0's, where N is the number of paths in the encryptor/decryptor cascade.

2. Form the plaintext into an array, A₀, of 1's and 0's, having N rows and P columns, wherein each column represents an N-bit data slice of the plaintext.

3. Create a new NxP array, T, by applying the mapping of the first encryptor stage independently to each column of A₀, and storing the mapping outputs in corresponding columns of T.

4. In each row of T, perform a right (or left) circular shift of the data by a number of positions equal to the delay value corresponding to that row in the first stage of the encryptor. Call the resulting array A₁. Delay values larger than the block size are acceptable in the block mode, as are negative delay values. However, since the shifts are circular, redundant configurations may be avoided by restricting the range of allowable delays (shifts) to be greater than −P/2 and less than +P/2. If positive delays correspond to right circular shifts then negative delays correspond to left circular shifts, and vice-versa.

5. Repeat Steps 3 and 4 for the second stage, starting with array A₁ as input in step 3. This produces array A₂ in Step 4.

6. Continue this iterative process for all remaining stages in sequence. The NxP array A_{K} generated in the K^{th} iteration is the desired ciphertext block.

Block decryption is performed similarly to block encryption, except that the order of mapping and shifting is reversed and, with reference to FIG. 6, the quantity D_{S} is set to zero. The resultant negative delay values indicate circular shifts in the opposite directions of those used for block encryption, i.e., if right (left) circular shifts are used for encryption then left (right) shifts must be used for decryption. To decrypt:

1. Start with a block of P data slices of ciphertext.

2. Form the ciphertext into an array, A₀, of 1's and 0's, having N rows and P columns, wherein each column represents an N-bit data slice of the ciphertext.

3. In each row of A₀, perform a right (or left) circular shift of the data by a number of positions equal to the delay value for that row in the first stage of the decryptor. Call the resulting array T.

4. Create a new NxP array, A₁, by applying the mapping of the first decryptor stage independently to each column of T, and store the mapping outputs in corresponding columns of A₁.

5. Repeat Steps C and D for the second decryptor stage, starting with array Al as input in Step C. This produces array A₂ in Step D.

6. Continue this iterative process for all remaining stages in sequence. The NxP array AK generated in the K^{th} iteration is the desired plaintext block.

In order for the block encryption technique to operate properly, the decryptor needs to know the position of the starting symbol of the received block of ciphertext. In other words the self-synchronizing feature of the stream mode does not extend to the block mode.

The block encryption mode is compatible with the data-dependent mapping selection schemes described in FIGS. 8-10. In this case, and for each stage, the encryption mappings used for given columns of data in Array T of encryption Step 3, are determined by performing stage-specific selection functions on the N-tuples of selected lower-indexed (i.e., previously processed) columns of that same array (feedback). Similarly, the mappings used in decryption Step D, will depend on the N-tuples in lower-indexed columns of Array T (feed-forward). However, in both cases the mappings used at the very beginning of the processing remain unspecified, thereby giving rise to a start-up ambiguity. The ambiguity can be resolved by initializing the mapping selector indices stored in the control delay elements of each stage, to predetermined values (e.g., “1”) prior to the start of processing. Unambiguous results are assured by using identical initialization conditions in both the encryptor and decryptor.

The technique of random bit insertion described above for the stream cipher mode works identically for block encryption. In this case the N bits comprising each of the P input plaintext data slices contain N-q information bits and q random bits. After decryption the random bits are discarded, leaving N-q information-bearing plaintext bits per data slice.

Turning now to the problem of parameter generation based on randomly selected user-defined keys, it is considerably more complex computationally to seed a practical pseudo-random sequence generator with a number, or key, comprising a large number of bits than with one having fewer bits. Modern encryption schemes generally operate with key lengths of 64, 128 or 256 bits, all of which are impracticably large to serve as seed values for most pseudo-random sequence generators. The approach described below overcomes this limitation by drawing numbers in a prescribed order (e.g., round-robin) from a multiplicity of generally different pseudo-random sequence generators, each of which is seeded with a different subset of bits derived from the overall key. The overall key length of the composite system is the total number of bits used to seed all of the short-sequence generators. One example of this approach is described in detail below, in which a composite key length of 4N bits is achieved through the use of four different sequence generators, each of which is seeded with N bits. The principles embodied in this example apply equally well to systems of other than four generators, and of course different values of N.

In our example, individual generators produce unique sequences of N bit numbers in accordance with the following recursive algorithm:

Let Rᵢ be the N-bit number produced at instant i, with R₀ being the initial seed value. Then

Tᵢ=[C·Rᵢ₋₁+A]_{mod S}, where S=2^{N}, and

Rᵢ=Right circular shift of Tᵢ by L places.

Different sequences are produced by selecting different values of the parameters A, C and L. In an illustrative embodiment, the following values of A, C and L are used for four 16-bit generators respectively:

| Generator | C | A | L |
|---|---|---|---|
| 1 | 6015 | 13678 | 7 |
| 2 | 20531 | 22422 | 7 |
| 3 | 46883 | 30402 | 7 |
| 4 | 62197 | 27739 | 7 |

These values of C, A and L produce full-period sequences of 16-bit numbers (i.e., sequences having periods of 2¹⁶=65,536). More generally, the period of any pseudo random generator generating N-bit numbers should be 2^{N} for this application. Such pseudo-random number generators that produce full-period sequences are particularly important in this application. Pseudo-random generators not meeting this constraint will have some initializations that yield output sequences having a small period, resulting in diminished “randomness” in the tables and parameters determined by the key schedule. Such initialization keys are termed “weak keys”, and encryption systems incorporating such weak keys are unattractive to users, even if the probability of choosing one at random is quite small.

We have determined by exhaustive search that there are a substantial number of combinations of C, A and L that yield full-period sequences for the above algorithm. In addition, it is desirable for the multiplicative constant, C, to have a large prime factor, and for the additive factor, A, to have many non-zero bits. It is believed that sequences produced by configurations of this type exhibit the highest degree of apparent randomness.

The four generators described above produce sequences that contain all possible 16-bit numbers, albeit in different numerical order. Consequently, the composite sequence obtained by drawing results from these in round robin fashion has period 4·2^{16.} Further, there are 2⁶⁴ unique initial states of the four-generator system, corresponding to a composite key length of 64 bits. Additionally, because all four generators produce full-period sequences, the above properties will obtain using any randomly chosen 64 bit key.

A desirable property of encryption systems is to have each bit of the key influence as many parameters of the encryptor as possible. This condition is only partially satisfied in the round robin approach, because the initial state of an individual generator depends on only 16 of the original key bits instead of all 64. Consequently it will often be the case that changes in some of the key bits will affect only one of the four generators, resulting in situations in which the modified key causes change in only every fourth number in the composite (round-robin) sequence. Such situations are preferably avoided.

In order to combat this effect, a preprocessing operation can be performed on the user-defined key which results in four new 16 bit seed values that depend more fully on all 64 key bits. After each of the generators is seeded with a different 16 bit segment of the original 64 bit key, each generator is then cycled at least four times, to produce a new set of four 16 bit numbers, which in general will be different from the original seed values in many bit positions. Modified seed values are then composed by selecting subsets of four bits from each of the four generated numbers, and arranging them to form new 16 bit seeds. In such bit selection, each of the available 64 bits is used once and only once, and each new seed contains exactly four bits from each of the four generators.

Many different algorithms can be written for computing encryptor/decryptor parameters (tables and delays) given a sequence of pseudo random numbers, and all will work equally well in a key schedule for the disclosed encryption/decryption technique. A common requirement in all of these is the need to select pseudo-random integers generally uniformly distributed over a range between zero and an upper limit U, the value of U generally depending on the specific encryptor/decryptor parameter under consideration. One convenient approach for generating uniformly distributed integers is to consider each number drawn from the composite pseudo-random sequence generator to be a 16-bit binary fraction with value between 0 and 1-2⁻¹⁶. Uniformly distributed integers in the range 0-U are produced by multiplying these 16-bit fractions by U+1 and taking the integer part of the resultant product.

It will be apparent to those skilled in the art that modifications to and variations of the disclosed methods and apparatus are possible without departing from the inventive concepts disclosed herein, and therefore the invention should not be viewed as limited except to the full scope and spirit of the appended claims.

What is claimed is:

1. A method of securely transmitting data, comprising:
continually applying data slices of the data to an encryptor having a cascade of encryptor stages, each encryptor stage including a respective mapping function and a respective delay function collectively operative in a predetermined order to generate encryptor stage output data slices from encryptor stage input data slices, the mapping function of each encryptor stage performing a stage-specific direct mapping of data slice values to corresponding generally different data slice values, and the delay function of each encryptor stage applying stage-specific and generally different delays to individual symbols of data slices, the output data slices of the last encryptor stage being referred to as encrypted data slices;
transmitting the encrypted data slices through a transmission channel; and
applying the encrypted data slices received from the transmission channel to a decryptor having a cascade of stages, each decryptor stage including a respective inverse mapping function and a respective equalizing delay function collectively operative in the reverse of the predetermined order to generate decryptor stage output data slices from decryptor stage input data slices, the inverse mapping function of each decryptor stage performing the inverse of the mapping function and the equalizing delay function compensating the delay function of a corresponding one of the encryptor stages.

2. A method according to claim 1, wherein the data comprises a serial data stream, and further comprising:
demultiplexing the serial data stream to form the data slices applied to the encryptor; and
multiplexing together individual symbols of each of the data slices generated by the last stage of the decryptor to recover the serial data stream.

3. A method according to claim 1, wherein:
in each encryptor stage, the mapping function is performed on the encryptor stage input data slices to generate mapped data slices, and the delay function is performed on the mapped data slices to generate the encryptor stage output data slices; and
in each decryptor stage, the equalizing delay function is performed on the decryptor stage input data slices to generate delayed data slices, and the inverse mapping function is performed on the delayed data slices to generate the decryptor stage output data slices.

4. A method according to claim 1, wherein:
in each encryptor stage, the delay function is performed on the encryptor stage input data slices to generate delayed data slices, and the mapping function is performed on the delayed data slices to generate the encryptor stage output data slices; and
in each decryptor stage, the inverse mapping function is performed on the decryptor stage input data slices to generate inverse-mapped data slices, and the equalizing delay function is performed on the inverse-mapped data slices to generate the decryptor stage output data slices.

5. A method according to claim 1, wherein the mapping function, the delay function, the inverse mapping function, and the equalizing delay function are specified by parameters loaded into the encryption and decryption functions.

6. A method according to claim 5, further comprising calculating the parameters from a session key.

7. A method according to claim 6, wherein calculating the parameters from the session key comprises:
seeding each of a plurality of pseudo-random generators with respective corresponding portions of the session key, each pseudo-random generator generating a corresponding sequence of values;
drawing values from each of the respective sequences of values from the pseudo-random generators in a predetermined order to yield a composite sequence of values; and
applying a predetermined function to each of the composite sequence of values to yield corresponding ones of the parameters.

8. A method according to claim 7, wherein the period of the sequence generated by each pseudo-random generator is a maximum period equal to 2^{N(p)}, where N(p) is the number of bits in the numbers generated by pseudo-random generator p.

9. A method according to claim 8, wherein each pseudo-random generator generates a sequence {Rᵢ} by performing a calculation of the form:
Tᵢ=[C·Rᵢ₋₁+A]_{mod S}, where S=2^{N}, and
Rᵢ=Right circular shift of Tᵢ by L places,
wherein the parameters C, A and L are chosen to ensure the maximum period of the sequence {Rᵢ}.

10. A method according to claim 7, wherein the predetermined order is round-robin order.

11. A method according to claim 7, wherein the predetermined function comprises treating each value from the composite sequence as a corresponding fraction, and calculating each parameter as the integer portion of the product of the corresponding fraction from the composite sequence and a predetermined maximum integer value of the parameter.

12. A method according to claim 7, further comprising:
after each of the pseudo-random generators is seeded with a different portion of the session key, cycling each generator at least a predetermined number of times to produce a new set of values;
selecting subsets of bits from the new set of values and arranging the selected subsets to compose new seed values for the pseudo-random generators, the subsets being arranged such that new seed values are generally functions of subsets of bits from all the pseudo-random generators; and
seeding the pseudo-random generators with the new seed values.

13. A method according to claim 6, further comprising receiving the session key from a key distribution system.

14. A method according to claim 5, wherein the mapping function, the delay function, the inverse mapping function, and the equalizing delay function are constant throughout a data transfer session.

15. A method according to claim 5, wherein the mapping function and the delay function of the encryptor are selected independently in each clock cycle using fed-back intermediate data in the encryptor, and the inverse mapping function and the equalizing delay function of the decryptor are selected independently in each clock cycle using fed-forward intermediate data in the decryptor.

16. A method according to claim 15, wherein the mapping function used in each given stage of the encryptor is selected based on fed-back intermediate data of the given encryptor stage and intermediate data of some or all subsequent encryptor stages, and the inverse mapping function used in each given stage of the decryptor is selected based on fed-forward intermediate data of the given decryptor stage and intermediate data of some or all preceding decryptor stages.

17. A method according to claim 15, wherein the mapping function used in each given stage of the encryptor is selected based only on fed-back intermediate data of the given encryptor stage, and the inverse mapping function used in each given stage of the decryptor is selected based only on fed-forward intermediate data of the given decryptor stage.

18. A method according to claim 1, wherein:
the data applied to the encryptor, transmitted on the transmission channel, and passed among the stages of the encryptor and decryptor comprises respective data blocks each having an integer number of slices;
each stage of the encryptor is operative to create an encryptor stage output block by applying the stage mapping function and the stage delay function in a predetermined order to an encryptor stage input block, the stage mapping function operating on individual slices of data blocks, and the stage delay function operating on sets of symbols, the symbols of each set occupying the same position in all data slices, the output block of the last encryptor stage constituting an encrypted data block transmitted on the transmission channel; and
each stage of the decryptor is operative to create a decryptor stage output block by applying the stage inverse mapping function and the stage equalizing delay function in the reverse of the predetermined order to a decryptor stage input block, the stage inverse mapping function operating on individual slices of data blocks, and the stage equalizing delay function operating on sets of symbols, the symbols of each set occupying the same position in all data slices.

19. A method according to claim 1, wherein the encryptor has at least one extra input more than the width of the data slices applied to the encryptor, and further comprising inserting a random bit stream into the extra input of the encryptor to randomize the encryption of the data stream such that multiple instances of identical data streams generally result in different streams of encrypted data slices.

20. A system for securely transmitting a data stream, comprising:
an encryptor continually receiving data slices of the data stream, the encryptor having a cascade of encryptor stages, each encryptor stage including a respective mapping function and a respective delay function collectively operative to generate encryptor stage output data slices from encryptor stage input data slices, the mapping function of each encryptor stage performing a stage-specific direct mapping of data slice values to corresponding generally different data slice values, and the delay function of each encryptor stage applying stage-specific and generally different delays to individual symbols of data slices, the output data slices of the last encryptor stage being referred to as encrypted data slices;
a transmission channel operative to transmit the encrypted data; and
a decryptor continually receiving the encrypted data slices received from the transmission channel, the decryptor having a cascade of stages, each decryptor stage including a respective inverse mapping function and a respective equalizing delay function collectively operative to generate decryptor stage output data slices from decryptor stage input data slices, the inverse mapping function of each decryptor stage performing the inverse of the mapping function and the equalizing delay function compensating the delay function of a corresponding one of the encryptor stages.

21. A system according to claim 20, wherein the data stream is a serial data stream, and further comprising:
a demultiplexer operative to demultiplex the serial data stream to form the data slices applied to the encryptor; and
a multiplexer operative to multiplex together individual symbols of each of the data slices generated by the last stage of the decryptor to recover the serial data stream.

22. A system according to claim 20, wherein:
in each encryptor stage, the mapping function is performed on the encryptor stage input data slices to generate mapped data slices, and the delay function is performed on the mapped data slices to generate the encryptor stage output data slices; and
in each decryptor stage, the equalizing delay function is performed on the decryptor stage input data slices to generate delayed data slices, and the inverse mapping function is performed on the delayed data slices to generate the decryptor stage output data slices.

23. A system according to claim 20, wherein:
in each encryptor stage, the delay function is performed on the encryptor stage input data slices to generate delayed data slices, and the mapping function is performed on the delayed data slices to generate the encryptor stage output data slices; and
in each decryptor stage, the inverse mapping function is performed on the decryptor stage input data slices to generate inverse-mapped data slices, and the equalizing delay function is performed on the inverse-mapped data slices to generate the decryptor stage output data slices.

24. A system according to claim 20, wherein the mapping function, the delay function, the inverse mapping function, and the equalizing delay function are specified by parameters loaded into the encryption and decryption functions.

25. A system according to claim 24, wherein the encryptor and decryptor each include a respective processor operative to calculate the respective parameters from a session key.

26. A system according to claim 25, wherein calculating the parameters from the session key comprises:
seeding each of a plurality of pseudo-random generators with respective corresponding portions of the session key, each pseudo-random generator generating a corresponding sequence of values;
drawing values from each of the respective sequences of values from the pseudo-random generators in a predetermined order to yield a composite sequence of values; and
applying a predetermined function to each of the composite sequence of values to yield corresponding ones of the parameters.

27. A system according to claim 26, wherein the period of the sequence generated by each pseudo-random generator is a maximum period equal to 2^{N(p)}, where N(p) is the number of bits in the numbers generated by pseudo-random generator p.

28. A system according to claim 27, wherein each pseudo-random generator generates a sequence {Rᵢ} by performing a calculation of the form:
Tᵢ=[C·R_{i -1}+A]_{mod S}, where S=2^{N}, and
Rᵢ=Right circular shift of Tᵢ by L places,
wherein the parameters C, A and L are chosen to ensure the maximum period of the sequence {Rᵢ}.

29. A system according to claim 26, wherein the predetermined order is round-robin order.

30. A system according to claim 26, wherein the predetermined function comprises treating each value from the composite sequence as a corresponding fraction, and calculating each parameter as the integer portion of the product of the corresponding fraction from the composite sequence and a predetermined maximum integer value of the parameter.

31. A system according to claim 26, wherein the respective processors of the encryptor and decryptor are further operative:
after each of the pseudo-random generators is seeded with a different portion of the session key, to cycle each generator at least a predetermined number of times to produce a new set of values;
to select subsets of bits from the new set of values and arrange the selected subsets to compose new seed values for the pseudo-random generators, the subsets being arranged such that new seed values are generally functions of subsets of bits from all the pseudo-random generators; and
to seed the pseudo-random generators with the new seed values.

32. A system according to claim 25, wherein the encryptor and decryptor each receive the session key from a key distribution system.

33. A system according to claim 24, wherein the mapping function, the delay function, the inverse mapping function, and the equalizing delay function are constant throughout a data transfer session.

34. A system according to claim 24, wherein the mapping function and the delay function of the encryptor are selected independently in each clock cycle using fed-back intermediate data in the encryptor, and the inverse mapping function and the equalizing delay function of the decryptor are selected independently in each clock cycle using fed-forward intermediate data in the decryptor.

35. A system according to claim 34, wherein the mapping function used in each given stage of the encryptor is selected based on fed-back intermediate data of the given encryptor stage and intermediate data of some or all subsequent encryptor stages, and the inverse mapping function used in each given stage of the decryptor is selected based on fed-forward intermediate data of the given decryptor stage and intermediate data of some or all preceding decryptor stages.

36. A system according to claim 34, wherein the mapping function used in each given stage of the encryptor is selected based only on fed-back intermediate data of the given encryptor stage, and the inverse mapping function used in each given stage of the decryptor is selected based only on fed-forward intermediate data of the given decryptor stage.

37. A system according to claim 20, wherein:
the data applied to the encryptor, transmitted on the transmission channel, and passed among the stages of the encryptor and decryptor comprises respective data blocks each having an integer number of slices;
each stage of the encryptor is operative to create an encryptor stage output block by applying the stage mapping function and the stage delay function in a predetermined order to an encryptor stage input block, the stage mapping function operating on individual slices of data blocks, and the stage delay function operating on sets of symbols, the symbols of each set occupying the same position in all data slices, the output block of the last encryptor stage constituting an encrypted data block transmitted on the transmission channel; and
each stage of the decryptor is operative to create a decryptor stage output block by applying the stage inverse mapping function and the stage equalizing delay function in the reverse of the predetermined order to a decryptor stage input block, the stage inverse mapping function operating on individual slices of data blocks, and the stage equalizing delay function operating on sets of symbols, the symbols of each set occupying the same position in all data slices.

38. A system according to claim 20, wherein the encryptor has at least one extra input more than the width of the data slices applied to the encryptor, and wherein a random bit stream is inserted into the extra input of the encryptor to randomize the encryption of the data stream such that multiple instances of identical data streams generally result in different streams of encrypted data slices.
